(19) United States
(12) Patent Application Publication
(10) Pub. No.: US 2013/0332857 A1
(43) Pub. Date: Dec. 12, 2013

(54) PHOTO EDIT HISTORY SHARED ACROSS USERS IN CLOUD SYSTEM

(71) Applicant: Samsung Electronics Co., Ltd., Suwon (KR)

(72) Inventors: Byoungju Kim, Walnut Creek, CA (US); Prashant Desai, San Francisco, CA (US)

(21) Appl. No.: 13/912,673

(22) Filed: Jun. 7, 2013

Related U.S. Application Data
(60) Provisional application No. 61/781,704, filed on Mar. 14, 2013.
(60) Provisional application No. 61/657,587, filed on Jun. 8, 2012.

(51) Int. Cl. H04L 29/06

(52) U.S. Cl. CPC H04L 65/403
USPC 715/753

(57) ABSTRACT

A method of sharing image editing history comprises using an electronic device for editing image content maintained on a network, storing image editing history of the image content in the network, selecting one or more image edits from the stored image editing history, and applying the selected image edits for personalizing another version of the image content.

### CROSS-REFERENCE TO RELATED APPLICATIONS

This application claims the priority benefit of U.S. Provisional Patent Application Ser. No. 61/657,587, filed Jun. 8, 2012, and U.S. Provisional Patent Application Ser. No. 61/781,704, filed Mar. 14, 2013, both incorporated herein by reference in their entirety.

### TECHNICAL FIELD

One or more embodiments relate generally to collaborative media editing and, in particular, to sharing media edit history and borrowing media edits on an electronic device.

### BACKGROUND

With the proliferation of electronic devices such as mobile electronic devices, users use the electronic devices for taking photos and photo editing. When a photo is taken or downloaded onto an electronic device, modification or editing of the photo is local to the electronic device.

### SUMMARY

One or more embodiments relate generally to using an electronic device for editing image content maintained in a network. One embodiment provides sharing and using photo edits through a cloud environment.

In one embodiment, a method of sharing image editing history comprises using an electronic device for editing image content maintained on a network, storing image editing history of the image content in the network, selecting one or more image edits from the stored image editing history, and applying the selected image edits for personalizing another version of the image content.

Another embodiment comprises an electronic device. The electronic device comprising a camera, a display and a mobile image gallery module. In one embodiment, the mobile image gallery module provides for using image edit history; wherein image editing history is shared within a network.

One embodiment comprises a computer program product for sharing image editing history. The computer program product comprising a tangible storage medium readable by a computer system and storing instructions for execution by the computer system for performing a method. The method comprising using an electronic editing for editing image content maintained on a network. Image editing history of the image content is stored in the network. One or more image edits is selected from the stored image editing history. The selected image edits are applied for personalizing another version of said image content.

Another embodiment comprises a graphical user interface (GUI) displayed on a display of an electronic device. The GUI comprising an edit history list for an image showing history of image edits from one or more contributors. The edit history list shown on the display is selectable for applying edits of one or more contributors for creating another version of the image. The image is captured via a camera of the electronic device or obtained from a network.

These and other aspects and advantages of the one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of one or more embodiments, as well as a preferred mode of use, reference should be made to the following detailed description read in conjunction with the accompanying drawings, in which:

FIGS. 1A-1B show block diagrams of architecture on a system for sharing photo edits, according to an embodiment.

FIG. 2 shows an example of an original authored photo and editing history, according to an embodiment.

FIGS. 3A-3C show examples of collaborator photo edits and edit histories, according to an embodiment.

FIG. 4 shows a flowchart of a process for sharing photo edits, according to an embodiment.

FIG. 5 is a high-level block diagram showing an information processing system comprising a computing system implementing an embodiment.

FIG. 6 shows a computing environment for implementing an embodiment.

FIG. 7 shows a computing environment for implementing an embodiment.

FIG. 8 shows a computing environment for sharing media edit history, according to an embodiment.

FIG. 9 shows a block diagram of an architecture for a local endpoint host, according to an example embodiment.

### DETAILED DESCRIPTION

The following description is made for the purpose of illustrating the general principles of the one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to using an electronic device for editing image content maintained in a network. One embodiment provides sharing and using photo edits through a cloud environment.

In one embodiment, the electronic device comprises a mobile electronic device capable of data communication over a communication link such as a wireless communication link. Examples of such mobile device include a mobile phone device, a mobile tablet device, smart mobile devices, etc.

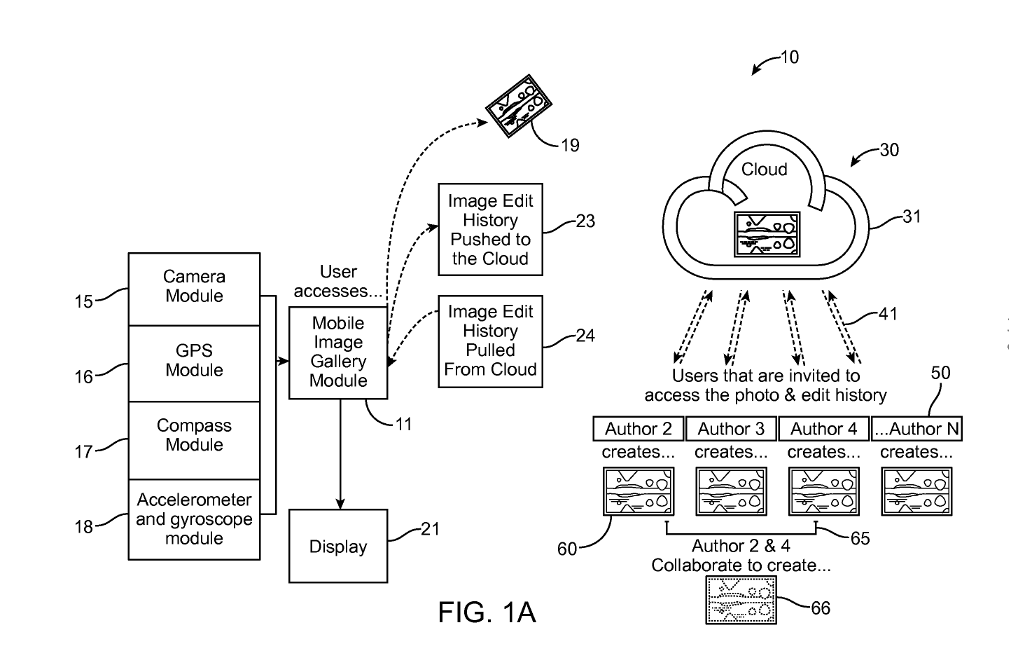

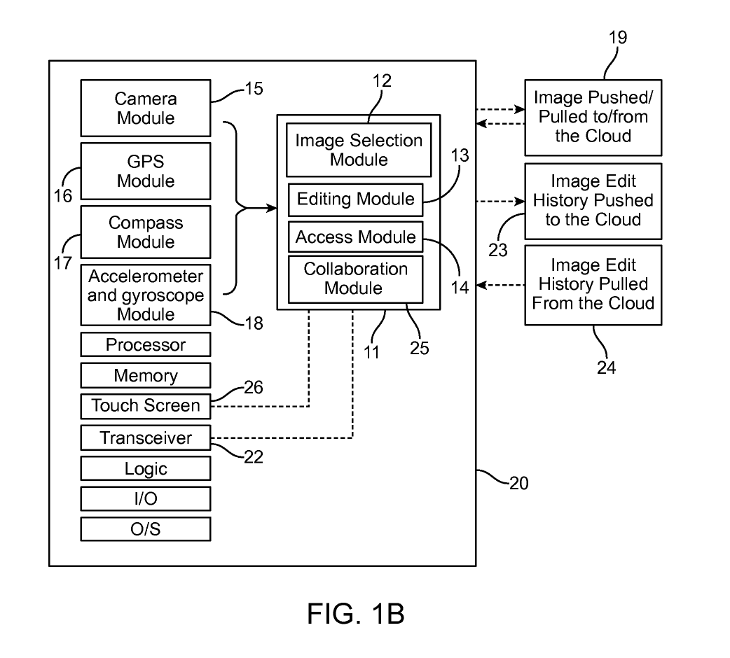

FIG. 1A shows a functional block diagram of an embodiment of a photo edit sharing system 10 for providing using an electronic device (such as mobile device 20 as shown in FIG. 1B) for sharing photo edits and editing history, according to an embodiment.

The system 10 comprises a mobile image gallery module 11 including an image selection module 12 (FIG. 1B), an editing module 13 (FIG. 1B), an access module 14 (FIG. 1B), and a collaboration module 25 (FIG. 1B). The mobile image gallery module 11 utilizes mobile device hardware functionality including one or more of: camera module 15, global positioning satellite (GPS) receiver module 16, compass module 17, and accelerometer and gyroscope module 18.

The camera module 15 is used to capture images of objects, such as people, surroundings, places, etc. The GPS module 16 is used to identify a current location of the mobile device 20 (i.e., user). The compass module 17 is used to identify direction of the mobile device. The accelerometer and gyroscope module 18 is used to identify tilt of the mobile device and distribute point-of-interest (POI) icons in space.

The system 10 provides photo editing, sharing of: photos, edits and edit history, and display of photo editing, photos, and edit history on the display 21 of the mobile device 20. The system 10 provides a simple, fluid, and responsive user experience.

The sharing of photos, photo edits, and photo editing history for creating personalized versions or for collaboration for providing different versions of photos from originally authored photos comprises integrating information including camera data, editing data, and optionally, location data, sensor data (i.e., magnetic field, accelerometer, rotation vector), etc. For example, Google Android mobile operating system application programming interface (API) components providing such information can be employed.

In one embodiment, one or more photo images 19 and image edit history 23 are uploaded (i.e., pushed) from the mobile image gallery module 11 of mobile device 20 to a network 30 (e.g., using transceiver 22 as shown in FIG. 1B) including a cloud environment 31, or photo images 19 and image edit history 24 may be downloaded (i.e., pulled) from the network 30 (e.g., using transceiver 22) to the mobile image gallery module 11 of mobile device 20.

In one example, an originally authored photo image 19 that is maintained in the cloud environment 31 of the network 30, along with editing history 23 may be accessed by other users 50 upon invitation or being granted access to the originally authored photo image(s) 19 and the pushed image edit history 23. In one implementation, other authors 50 may each create a new version 60 of the originally authored photo image 19. In one example, multiple additional authors may collaborate editing together (e.g., authors 2 and 4 provide collaboration 65) to derive a new version 66 of the originally authored photo image 19. The image edit history lists that are shared are accessed by uploading/downloading from a mobile device (e.g., mobile device 20) to/from the cloud environment 31 by pushing/pulling 41.

In one embodiment, a user aims a camera of a mobile device (e.g., smartphone, tablet, smart device) including the mobile image gallery module 11, towards a target object, for example, an object, a scene, or a person at a physical location, such as a city center the user is visiting and takes a photo. The photo from the camera application (e.g., camera module 15) is processed by the mobile device 20 and displayed on a display 21 of the mobile device 20.

In one embodiment, once activated, the mobile image gallery module 11 enables the user (original author) to edit the photo image (e.g., using touch screen 26 in FIG. 1B) they took on the display 21 (e.g., crop, change color, enhance, add objects to the image, etc.). In one embodiment, using the mobile image gallery module 11, the edits (e.g., metadata) made to the photo image are stored locally to a memory of the mobile device 20 and tracked in the order made. In one example, time/date stamps may be provided in metadata for the edits. In one implementation, the tracked edits provide a road map of edit history of the photo image(s) 19.

In one embodiment, the mobile image gallery module 11 includes an image selection module 12 (FIG. 1B) that provides a selection function for selecting a photo image 19 and image edit history 23/24 for pushing/pulling to/from the cloud 31. An access module 14 provides an access grant/deny function for image photos 19 and image edit history for network 30 users to have the ability to access an authored photo image and image edit history. The collaboration module 25 provides the ability of applying edits from multiple users to an image photo 19 for creating a new version of an authored image photo together based on image edits shared through image edit histories or original edits from the collaborating users.

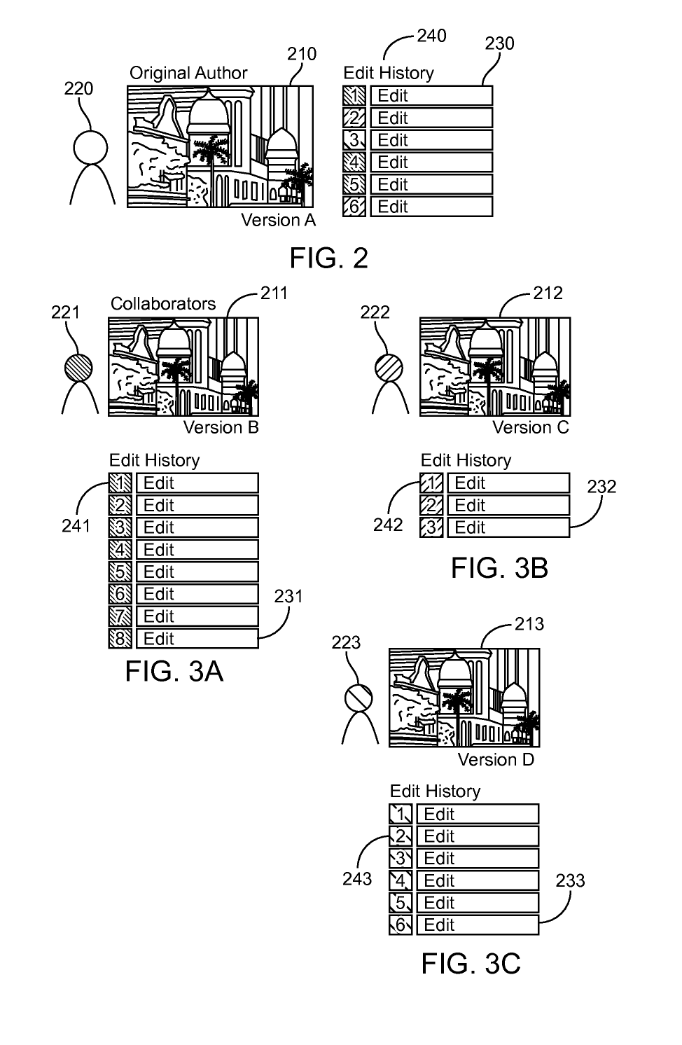

Referring to FIG. 2, an original authored photo image 210 (i.e., version A) is selected using the image selection module 12. A symbol or color 220 is displayed on the display 21 to distinguish the original author and edits to result in version A of the photo image 210.

FIG. 2 shows an example of an image edit history list/table that includes an ordered list of image edits 230 and a symbol (e.g., icons, initials, images, etc.) or color (e.g., blue, yellow, pink, etc.) 240 listed in image edit order for the associated authors of the image edits. In one embodiment, the associated authors of image edits 230 are distinguished from one another by the symbol or color. Additionally, the image edit history list shows the image edits 230 of an associated photo image in the order that the image edits 230 were made to an image photo. In one implementation, an author may share the image edits in the image edit history list with other users that may obtain the image edits from the cloud environment 31.

Using the editing module 13 of the mobile image gallery module 11, the shared image edits may be selected from the image edit history list in any order that the user chooses. Based on the selected image edits from the image edit history list, and any other edits that a user may desire to make, a new version of the photo image is created and a new image edit history list is created for the new version of the photo image. The new image edit history list includes indications of the associated author of the edits and lists the edits in order made for the specific version of the photo image. In one example, the image edit history list shown in FIG. 2 includes image edits 1, 4 and 5 from one collaborator (e.g., collaborator 221, FIG. 3A), image edits 2 and 6 from another collaborator (e.g., collaborator 222, FIG. 3B), and image edit 3 from yet another collaborator (collaborator 223, FIG. 3C).

FIGS. 3A-3C show photo images 211, 212 and 213 from different collaborators of an authored image photo. The different collaborators of the photo images 211, 212 and 213 have image edit history lists that include indications of the order of edits (241, 242 and 243) and the image edits made (231, 232 and 233). Each of the different collaborators is associated with a symbol or color (221, 222, and 223) to distinguish image edits in an image edit history list and/or photo images from one another.

In one example, the image edit history list for the author associated with the symbol/color 221 has eight image edits 231 ordered from 1 to 8 that have a symbol or color 241 (e.g., blue). In another example, the image edit history list for the author associated with the symbol/color 222 has three image edits 232 ordered from 1 to 3 that have a symbol or color 242 (e.g., yellow). In one example embodiment, the image edit history list for the author associated with the symbol/color 223 has six image edits 233 ordered from 1 to 6 that have a symbol or color 243 (e.g., pink). The collaborators 221, 222 and 223 that each created photo image versions (i.e., 211, 212 and 213) with the respective associated image edit history lists 231, 232 and 233 may use each other's image edits if access is granted with the access module 14.

In one embodiment, multiple collaborators may combine image edits of their own or shared from other image edit history lists to create a new version of a photo image. The collaborated image edits may then be shared with other collaborators through a newly created image edit history list that is stored on the cloud environment 31.

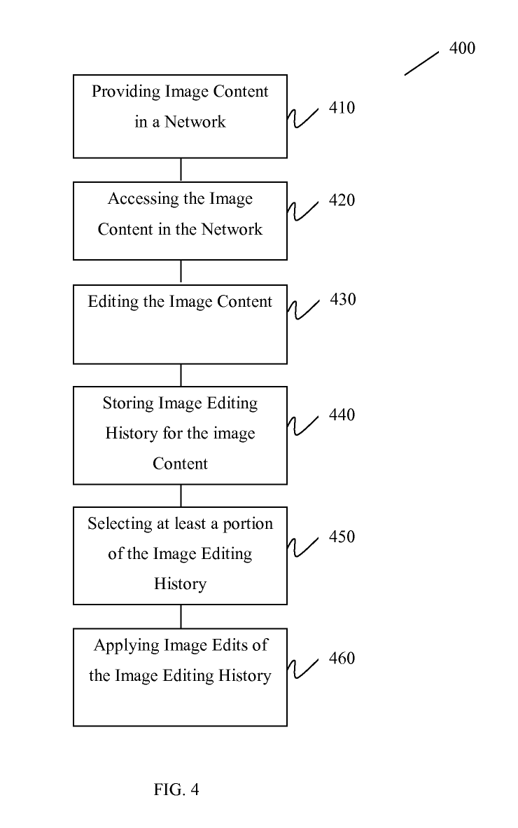

FIG. 4 shows a flowchart of an image edit sharing process 400, according to an embodiment. Process block 410 comprises providing image content in a network or cloud environment. Process block 420 comprises accessing the image content in the network. Process 430 comprises editing the image content. Process block 440 comprises storing image editing history for the image content. Process block 450 comprises selecting one or more image edits from the stored image editing history. Process block 460 comprises applying the selected image edits for creating a personalized version of the originally authored image content.

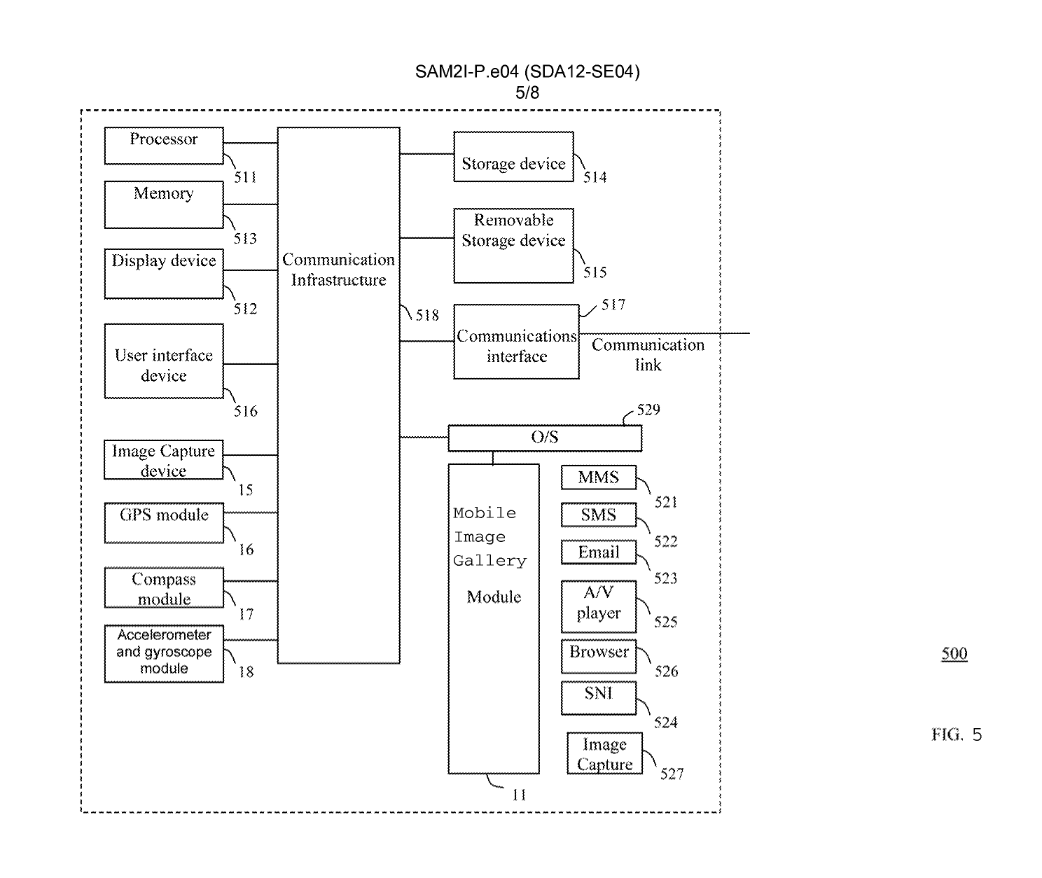

FIG. 5 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one example embodiment implemented in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes a mobile image gallery module 11 as described herein, according to an embodiment. In one implementation of said mobile image gallery module 11 along an operating system 529 may be implemented as executable code residing in a memory of the system 500. In another embodiment, such modules are in firmware, etc.

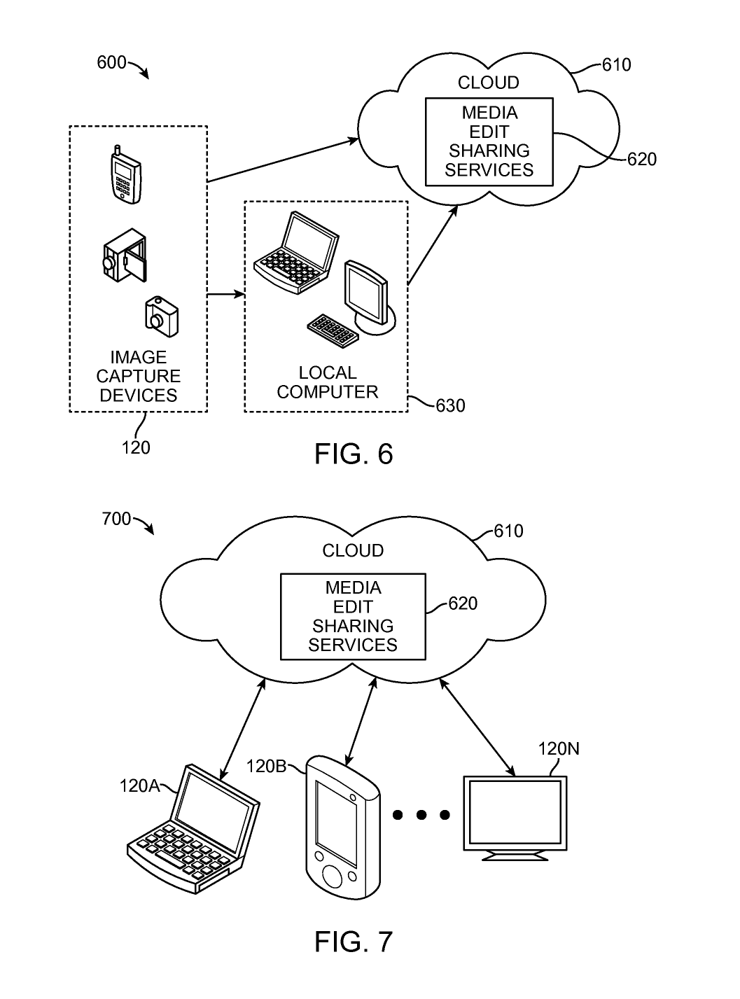

FIGS. 6 and 7 illustrate examples of networking environments 600 and 700 for cloud computing in which sharing media edit history embodiments described herein may utilize. In one embodiment, in the environment 600, the cloud 610 provides services 620 (such as sharing media edit history, social networking services, among other examples) for user computing devices, such as electronic device 120 and electronic device 20 (FIG. 1B). In one embodiment, services may be provided in the cloud 610 through cloud computing service providers, or through other providers of online services. In one example embodiment, the cloud-based services 620 may include media processing and edit history sharing services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, create or share comments, etc. In one embodiment, the electronic devices 120 may upload one or more digital images to the service 620 on the cloud 610 either directly (e.g., using a data transmission service of a telecommunications network) or by first transferring the one or more images to a local computer 630, such as a personal computer, mobile devices, wearable devices, or other network computing devices.

In one embodiment, as shown in environment 700 in FIG. 7, cloud 610 may also be used to provide services that include sharing media edit history embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 600 and 700, any of the embodiments may be implemented at least in part by cloud 610. In one embodiment example, sharing media edit history techniques are implemented in software on the local computer 630, one of the electronic devices 120, and/or electronic devices 120A-N. In another example embodiment, the sharing media edit history techniques are implemented in the cloud and applied to comments and media as they are uploaded to and stored in the cloud. In this scenario, the sharing media edit history embodiments may be performed using media stored in the cloud as well.

In one or more embodiments, media and media edit history may be shared across one or more social platforms from an electronic device 120. Typically, the shared media is only available to a user if the friend or family member shares it with the user by manually sending the media (e.g., via a multimedia messaging service (“MMS”)) or granting permission to access from a social network platform. Once the media is created and viewed, people typically enjoy sharing them with their friends and family, and sometimes the entire world. Viewers of the media will often want to add metadata or their own edits, thoughts and feelings about the media using paradigms like comments, “likes,” and tags of people.

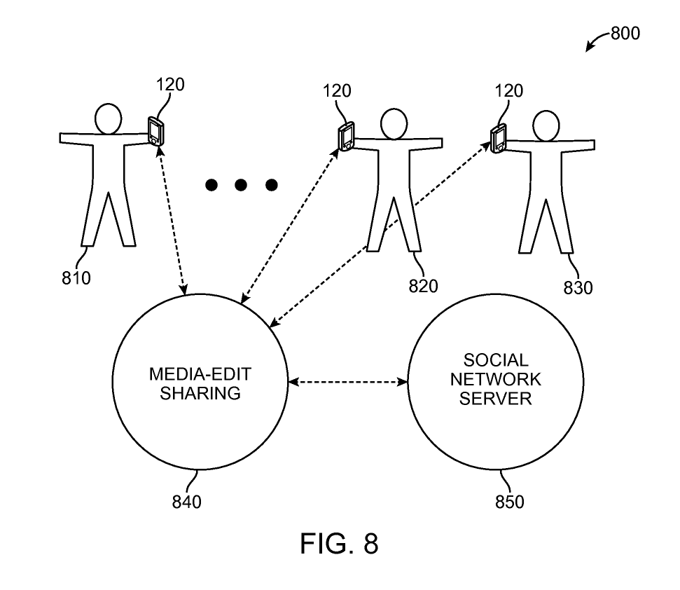

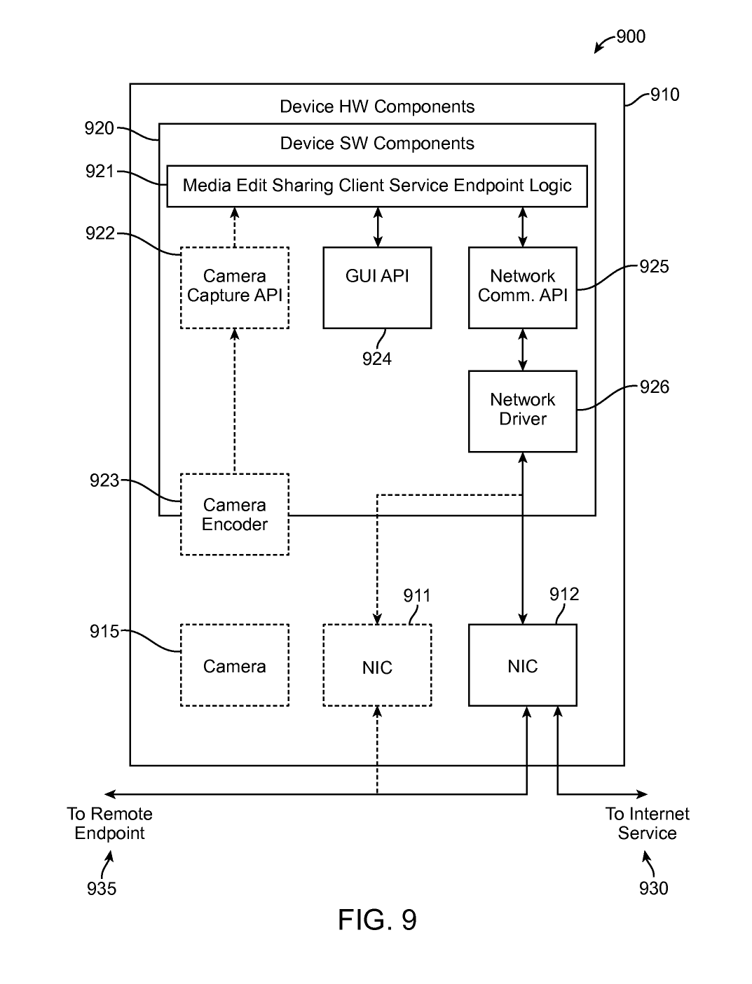

FIG. 8 is a block diagram 800 illustrating example users of an image processing for 3-D image effect system according to an embodiment. In one embodiment, users 810, 820, 830 are shown, each having a respective electronic device 120 that is capable of capturing and editing digital media (e.g., images, video, audio, or other such media) and providing sharing of media edit history. In one embodiment, the electronic devices 120 are configured to communicate with a media edit sharing controller 840, which is may be a remotely-located server, but may also be a controller implemented locally by one of the electronic devices 120. In one embodiment where the media edit sharing controller 840 is a remotely-located server, the server may be accessed using the wireless modem, communication network associated with the electronic device 120, etc. In one embodiment, the media edit sharing controller 840 is configured for two-way communication with the electronic devices 120. In one embodiment, the media edit sharing controller 820 is configured to communicate with and access data from one or more social network servers 850 (e.g., over a public network, such as the Internet).

In one embodiment, the social network servers 850 may be servers operated by any of a wide variety of social network providers (e.g., Facebook®, Instagram®, Flickr®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the image processing controller 840 may provide login and password information through an appropriate settings screen. In one embodiment, this information may then be stored by the media edit sharing controller 840. In one embodiment, a user's private or public social network information may be searched and accessed by communicating with the social network server 850, using an application programming interface (“API”) provided by the social network operator.

In one embodiment, the media edit sharing controller 840 performs operations associated with a media sharing application or method. In one example embodiment, the media edit sharing controller 840 may receive media from a plurality of users (or just from the local user), determine relationships between two or more of the users (e.g., according to user-selected criteria), and transmit media edit history information, comments and/or media to one or more users based on the determined relationships.

In one embodiment, the media edit sharing controller 840 need not be implemented by a remote server, as any one or more of the operations performed by the media edit sharing controller 840 may be performed locally by any of the electronic devices 120, or in another distributed computing environment (e.g., a cloud computing environment). In one embodiment, the sharing of media and media edit history may be performed locally at the electronic device 120.

FIG. 9 shows an architecture for a local endpoint host 900, according to an embodiment. In one embodiment, the local endpoint host 900 comprises a hardware (HW) portion 910 and a software (SW) portion 920. In one embodiment, the HW portion 910 comprises the camera 915, network interface (NIC) 911 (optional) and NIC 912 and a portion of the camera encoder 923 (optional). In one embodiment, the SW portion 920 comprises media edit sharing client service endpoint logic 921, camera capture API 922 (optional), a graphical user interface (GUI) API 924, network communication API 925, and network driver 926. In one embodiment, the content flow (e.g., text, graphics, photo, video and/or audio content, and/or reference content (e.g., a link)) flows to the remote endpoint in the direction of the flow 935, and communication of external links, graphic, photo, text, video and/or audio sources, etc. flow to a network service (e.g., Internet service) in the direction of flow 930.

One or more embodiments, use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's onmessage callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. A method of sharing image editing history comprising:
using an electronic device for editing image content maintained on a network;
storing image editing history of the image content in the network;
selecting one or more image edits from the stored image editing history; and
applying the selected image edits for personalizing another version of said image content.

2. The method of claim 1, further comprising:
providing image content; and
accessing the image content, wherein providing image content comprises uploading one or more images from the electronic device.

3. The method of claim 2, wherein accessing the image content is based on access privilege.

4. The method of claim 3, wherein access privilege for the image content is specified by an author of the image content.

5. The method of claim 4, further comprising applying one or more edits from the stored image editing history of the image content for collaborating image content edits for personalizing another version of the image content.

6. The method of claim 5, wherein editing history from multiple users are accessible across the network.

7. The method of claim 6, wherein the network is a cloud network.

8. The method of claim 7, wherein image editing history is pulled from or pushed to the cloud network for an image project.

9. The method of claim 1, wherein the electronic device comprises a mobile electronic device.

10. The method of claim 9, wherein the mobile electronic device comprises one of a mobile phone, a tablet device, and a mobile computing device.

11. The method of claim 1, wherein the image editing history is displayed such that edits of multiple users are distinguishable.

12. An electronic device, comprising:
a camera;
a display; and
a mobile image gallery module that provides for using image edit history;
wherein image editing history is shared within a network.

13. The electronic device of claim 12, wherein the electronic device provides for downloading of image content and image edit history from the network, wherein uploaded image content and image edit history is shared based on access privilege.

14. The electronic device of claim 13, wherein access privilege for the image content is assigned by the mobile image gallery module.

15. The electronic device of claim 14, wherein downloaded image editing history of the image content is used by the mobile image gallery module for collaborating image content edits for personalizing another version of the image content.

16. The electronic device of claim 14, wherein editing history from multiple users are accessible across the network by multiple electronic devices.

17. The electronic device of claim 14, wherein the network is a cloud network.

18. The electronic device of claim 12, wherein the electronic device comprises a mobile electronic device.

19. A computer program product for sharing image editing history, the computer program product comprising:
a tangible storage medium readable by a computer system and storing instructions for execution by the computer system for performing a method comprising:
using an electronic editing for editing image content maintained on a network;
storing image editing history of the image content in the network;
selecting one or more image edits from the stored image editing history; and
applying the selected image edits for personalizing another version of said image content.

20. The computer program product of claim 19, further comprising:
providing image content; and
accessing the image content, wherein providing image content comprises uploading one or more images from the electronic device.

21. The computer program product of claim 20, wherein accessing the image content is based on access privilege.

22. The computer program product of claim 21, further comprising applying one or more edits from the stored image editing history of said image content for collaborating image content edits for personalizing another version of said image content.

23. The computer program product of claim 22, wherein image editing history from multiple users are accessible across the network.

24. The computer program product of claim 23, wherein the network is a cloud network, and image editing history is pulled from or pushed to the cloud network for an image project by one or more mobile devices.

25. The computer program product of claim 19, further comprising distinguishing image editing history multiple users on a display.

26. A graphical user interface (GUI) displayed on a display of an electronic device, comprising:
an edit history list for an image showing history of image edits from one or more contributors, wherein the edit history list shown on the display being selectable for applying edits of one or more contributors for creating another version of the image, wherein the image is one of captured via a camera of the electronic device or obtained from a network.

27. The GUI of claim 26, further comprising:
an image created by one or more collaborators using one or more edits obtained from the edit history list.
